(19) United States
(12) Patent Application Publication
(10) Pub. No.: US 2004/0044550 A1
(43) Pub. Date: Mar. 4, 2004

(54) Online method and system for facilitating improvements in the consistency, deliverability and/or measurability of launch practices

(75) Inventors: Carl Self, Macomb, MI (US); Cynthia Taaffee, Farmington Hills, MI (US); Gordon Louis Hopcian, Novi, MI (US); Jeff Iannuzzi, Harrison Twp., MI (US); Julie Trosen, White Lake, MI (US); Rod Wendel, Plymouth, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/064,959

(22) Filed: Sep. 4, 2002

(51) Int. Cl. G06F 17/60

(52) U.S. Cl. 705/7

(57) ABSTRACT

The present invention relates to an online method and system for facilitating improved consistency, deliverability and/or measurability of a launch practice. A preferred method embodiment of the present invention includes determining a launch practice item based on a set of key sources and transmitting the launch practice item to an at least one member of the launch practice team. The launch practice item is determined by an experienced committee separate from a launch practice team. The at least one member uses the launch practice item to improve consistency, deliverability and/or measurability of the launch practice. A preferred computer system of the present invention is configured to transmit a launch practice item, receive an at least one member observation regarding the launch practice item, and transmit a revised and/or a new launch practice item if implementing the observation improves the consistency, deliverability and/or measurability of the launch practice.

### BACKGROUND OF INVENTION

1. Field of the Invention

This invention relates generally to an online method and system for facilitating improvements in the consistency, deliverability and/or measurability of launch practices.

2. Background Art

Customarily, members of a vehicle launch program in the automotive industry generally do not have a consistent method to share their launch experiences with members of other launch programs. Consequently, substantial inconsistencies between the practices of members of different launch programs are common. In addition, the best practices learned by members of different launch programs are rarely implemented across all launch programs. As a result, members of launch programs cannot leverage the useful knowledge learned by members of other launch programs.

For example, launch program A could use an off-the-shelf spreadsheet software package to conduct product cost studies. Launch program B could use a customized product costing software package provided by a software vendor. Although the custom package is more expensive than the off-the-shelf package, the custom package saves launch program B resources due to its superior functionality. However, launch program B commonly does not share this information with launch program A. This scenario commonly causes decreased efficiency and inconsistencies between launch programs.

What is needed is an online dynamic interactive method and system of facilitating improvements in the consistency, deliverability and/or measurability of launch practices by using shared experiences and observations of launch program members.

### SUMMARY OF INVENTION

The present invention relates to an online method and system for facilitating improved consistency, deliverability and/or measurability of a launch practice. One object of the present invention is to provide an online method and system for providing the most efficient launch practices across all launch programs. These standardized best practices can allow measurability of the health of a launch program by providing common metrics between launch programs. Another object of the present invention is to provide deliverables information to launch element owners in order to verify that a launch element executor or contributor is delivering what is necessary for success of the launch program. Yet another object of the present invention is to provide a mechanism for launch program members to make observations that are integrated into existing launch practices if integration improves the consistency, deliverability and/or measurability of launch practices.

A preferred method embodiment of the present invention includes determining a launch practice item based on a set of key sources and transmitting the launch practice item to an at least one member of the launch practice team. The launch practice item is preferably determined by an experienced committee separate from a launch program team. The at least one member uses the launch practice item to improve consistency, deliverability and/or measurability of the launch practice.

The preferred method embodiment of the present invention may additionally include receiving an at least one member observation regarding the launch practice item. The experienced committee decides to revise the launch practice item or to create a new launch practice item if implementing the member observation improves the consistency, deliverability and/or measurability of the launch practice. The revised launch practice item or new launch practice item is transmitted to the at least one member. The deciding step preferably lasts about one month to about three months.

The set of key sources can include lessons learned, launch principles, assembly plant launch process models, global craftsmanship, product quality planning initiatives, former body and assembly quality systems, former product production systems, milestone standards, and product development systems.

The launch practice item can be a launch element, procedure, guideline, standard, policy, or work instruction. If the launch practice item is a procedure, a document supporting the procedure preferably includes measurables and deliverables. If the launch practice item is a standard, the document supporting the standard preferably includes information regarding how the launch practice should be performed.

A preferred system embodiment of the present invention includes a computer system for transmitting a launch practice item to an at least one member of a launch practice team, receiving an at least one member observation regarding the launch practice item, and transmitting a revised launch practice item and/or a new launch practice implementing the at least one member observation if implementing the observation improves consistency, deliverability and/or measurability of the launch practice. The at least one member uses the defined launch practice item to improve consistency, deliverability and/or measurability of the launch practice.

The above objects and other objects, features and advantages of the present invention are readily apparent from the following detailed description of the best mode for carrying out the invention when taken in connection with the accompanying drawings.

### BRIEF DESCRIPTION OF DRAWINGS

FIG. 1 is a schematic diagram illustrating a preferred system for implementing the present invention;

FIG. 2 is a block flow diagram illustrating a preferred methodology for implementing the present invention;

FIG. 3 is a preferred GUI for displaying a list of launch elements in accord with the present invention;

FIG. 4 is a preferred GUI for graphically depicting a list of launch elements according to where the launch elements fall within a product development launch timeline;

FIG. 5 is a preferred GUI for displaying a list of guidelines in accord with the present invention; and

FIG. 6 is a preferred GUI for displaying a list of standards in accord with the present invention.

### DETAILED DESCRIPTION

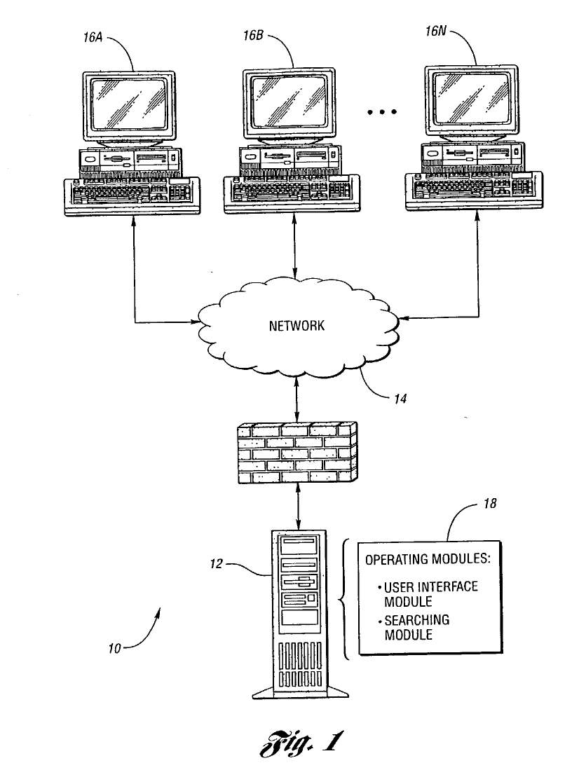

FIG. 1 is a schematic diagram illustrating a preferred system for implementing the present invention. Preferred system 10 includes an at least one server computer 12 operably serving a plurality of client computers 16A-N. Client computers 16A-N can include computers used by members of launch programs within an original equipment manufacturer (“OEM”) or members within an OEM supplier/vendor organization.

In accord with a preferred embodiment of the present invention, client computers 16A-N communicate with server computer 12 utilizing a TCP-IP communication protocol via the Internet.

Server computer 12 is configured to operably execute user interface and searching modules 18.

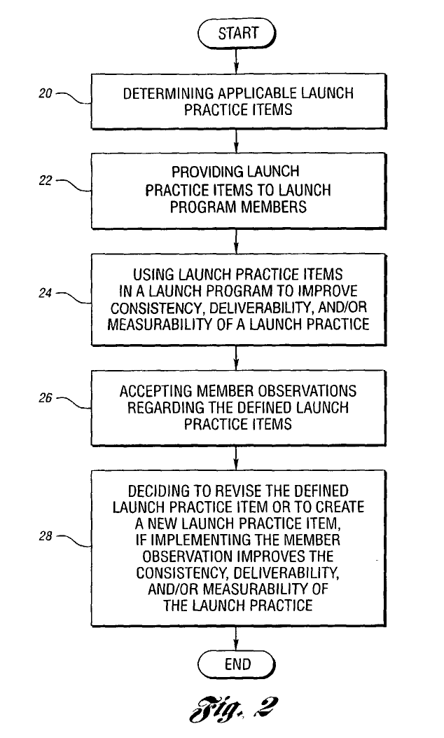

FIG. 2 represents a block flow diagram illustrating a preferred methodology for implementing the present invention. As represented in block 20, launch practice items are determined. Preferably, launch practice items are determined by an experienced committee separate from launch practice teams. Launch practice items are determined based on a set of key sources, which can include lessons learned, launch principles, assembly plant launch process models, global craftsmanship, product quality planning initiatives, former body and assembly quality systems, former production systems, milestone standards, and product development systems. Key sources can be determined by members of launch program teams or groups within an organization. The defined launch practice items are comprised of existing practices that should have been followed based on effectiveness of past launch programs. The launch practices are defined with an eye towards consistency between launch programs.

Preferably, launch practice items include launch elements, procedures, guidelines, standards, policies, and work instructions. Procedures define requirements for the launch elements. Guidelines, standards, work instructions, and policies support the execution of launch elements. Preferably, launch practice items are documented electronically and paper copies of the launch practice items are available by printing the electronic document.

It should be understood that launch elements refer to elements that fall within a product development launch cycle, from kick-off (KO) to final sign-off (FS). Preferably, the product development launch cycle includes the following milestones: kick-off (KO), strategic intent (SI), program approval (PA), product readiness (PR), change cutoff (CC), launch ready (LR), launch sign-off (LS), and final sign-off (FS). Launch elements can be characterized by where they fall in the product development launch cycle. For example, the “supplier sourcing” launch element falls between the SI and PA milestones.

It should be understood that procedures define minimum requirements for the launch element. The minimum requirements are preferably defined in terms of “who”, “what”, and “when”. The “who” preferably refers to a job title of an accountable individual. The “what” refers to deliverables and measurables. It is understood that deliverables can include providing input, a decision making event, or an action execution. It is understood that measurables refer to launch program events that can be quantified. It should be understood that the “when” refers to a specifically defined milestone during the product development launch cycle.

According to the present invention, procedures can include corporate procedures and/or local procedures. Corporate procedures preferably define minimum requirements for a launch element that affect product quality, customer satisfaction, or environmental performance. Corporate procedures are often created when one of the following conditions exist: (1) the corporate procedure is necessary to define an interface responsibility between major organizations; or (2) the complexity of work, methods used, or skills and training needed by personnel executing the launch element necessitates documenting the specific tasks, identifying responsibilities, timing and/or required training or qualifications. Local procedures are often created when one of the following conditions exist: (1) the local procedure is required by a corporate procedure; or (2) a manager determines that there is a need for the local procedure.

It should be understood that guidelines are a recommended course of conduct. Preferably, guidelines are developed and issued by management for items related to a manager's functional or operating area to provide guidance on “how” to accomplish a given set of deliverables.

It should be understood that standards are a collection of related requirements (e.g., known critical metrics), applicable through a common process (e.g., product development) to organizations with diverse responsibilities, whose actions are based on the related requirements. For example, corporate standards can refer to computer-based systems that are used to manage information flow and interactions of multiple groups.

It should be understood that work instructions provide specific instructions for completing individual tasks. In general, work instructions refer to “how” a task should be accomplished.

It should be understood that policies refer to statements of broad and basic principles that provide general direction and limits for business decisions and managerial actions. Corporate officers usually establish policies.

As represented in block 22, the defined launch practices are provided to members. Preferably, a main graphical user interface (GUI) hosted by server 12 includes links to allow a member to access an index of launch practices displayed by launch practice type. The GUI, like other GUIs provided in accord with the present invention, may be developed and/or configured utilizing a plurality of client-server interface languages and applications including but not limited to hypertext markup language (HTML), Pearl Script, Java Servlets and Java Script. Preferably, the main GUI includes links for “Elements”, “Guidelines”, “Standards”, and “Change Control”. The “Change Control” link will be discussed in more detail below.

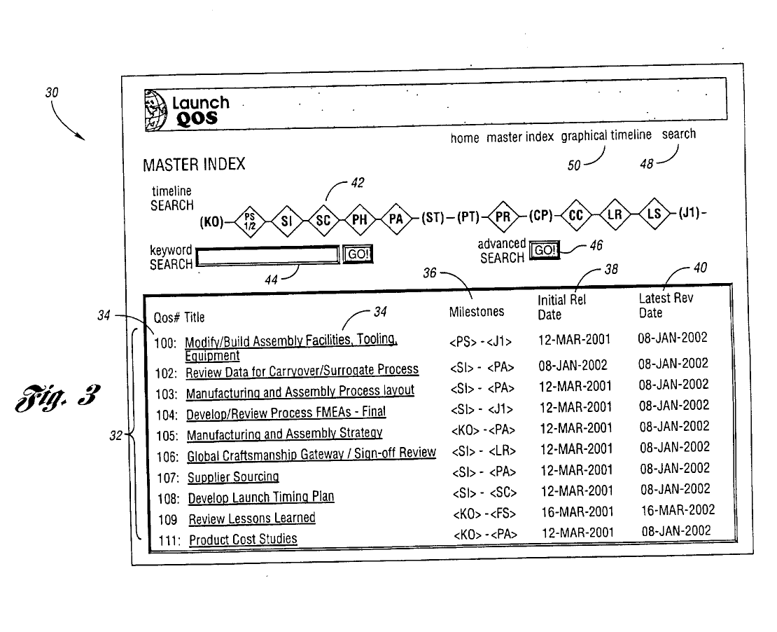

Upon selecting the “Elements” link, GUI 30 displays a list 32 of launch elements, as illustrated by FIG. 3. Preferably, each launch element is listed by a hyperlinked title 34, milestones 36, an initial release date 38, and a latest revision date 40. By selecting a hyperlinked title 34 of a launch element, a procedure document relating to the launch element is preferably displayed in a GUI.

GUI 30 also preferably includes a product development launch timeline 42 comprised of milestones. Members can conduct a timeline search by selecting a milestone. Upon selecting the milestone, a pop-up window is preferably displayed that contains a list of launch elements that are active during the selected milestone.

GUI 30 also preferably allows members to conduct a keyword search of the launch elements by entering a keyword in data input field 44. For example, upon entering the term “cost study” in data input field 44, searching module 18 searches for documents related to launch elements that contain the keyword. Preferably, a GUI displays the search results for the keyword as a list of hyperlinked launch element titles. Optionally, hyperlinked reference numbers and titles of documents supporting the launch elements are displayed. Examples of documents that support launch elements include guidelines, standards, work instruction and policies. The member can select the hyperlinked title to display the procedure document related to the launch element or select the hyperlinked reference number to display a supporting document.

GUI 30 also preferably allows members to conduct an advanced search by selecting the “Go” button 46. For example, the advanced search utility allows the member to search by launch elements that start at or end at certain milestones. Preferably, a GUI displays the search results for the keyword as a list of hyperlinked launch element titles. Optionally, hyperlinked reference numbers and titles of documents supporting the launch elements are displayed. Examples of documents that support launch elements include guidelines, standards, work instruction and policies. The member can select the hyperlinked title to display the procedure document related to the launch element or select the hyperlinked reference number to display a supporting document.

The searches before mentioned and other searches can be conducted by selecting the “search” link 48. Other searches preferably include measurables and deliverables searches. The member can select a particular milestone for the measurables and deliverables searches from the product development launch cycle preferably contained in a GUI. Searching module 18 preferably returns a list of measurables or deliverables for the selected milestone.

Additionally, a special search can be conducted by the member. The special search allows the member to search by launch principles or milestone standards, as well as other key sources.

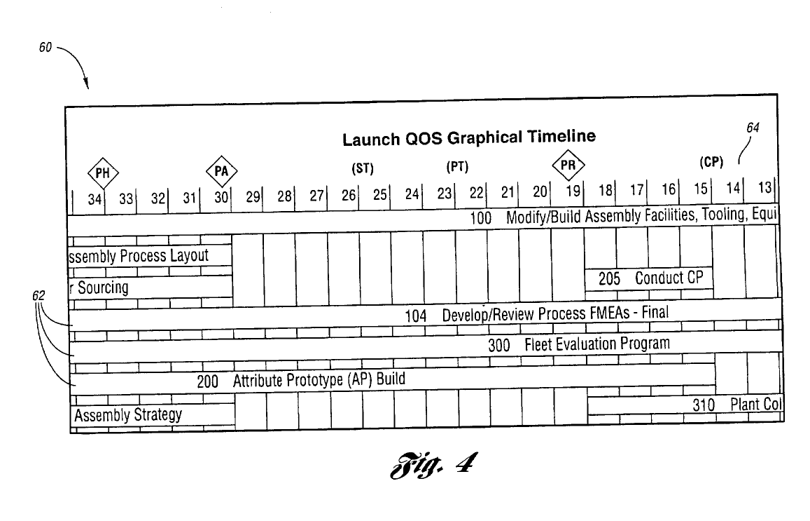

FIG. 4 illustrates a preferred GUI 60 for graphically displaying hyperlinked launch practice elements 62 in relation to where the elements fall within the product development launch timeline 64. Upon selecting the “graphical time line” link 50 on FIG. 3, GUI 60 is displayed. By selecting a hyperlinked launch practice element 62, the procedure supporting the launch practice element is preferably displayed.

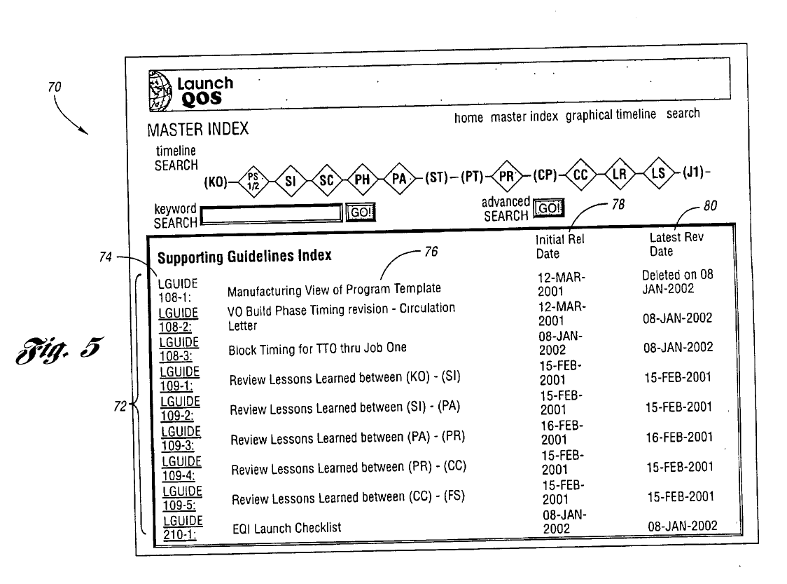

Upon selecting the “Guidelines” link, GUI 70 displays a list 72 of guidelines, as illustrated by FIG. 5. Preferably, each guideline is listed by a hyperlinked guideline reference number 74, a title 76, an initial release date 78, or a latest revision date 80. By selecting a hyperlinked guideline reference number 74, a corresponding guideline document is preferably displayed in a GUI.

GUI 70 also facilitates guideline searches, including, but not limited to, keyword searches, advanced searches, and time line searches. The member input and the results of the guideline search are similar to those for the corresponding launch elements search.

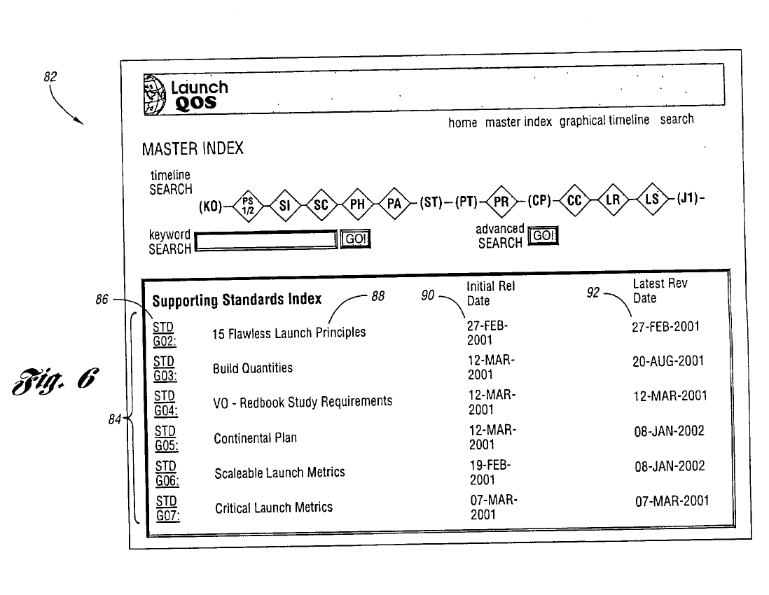

Upon selecting the “Standards” link, GUI 82 displays a list 84 of standards, as illustrated by FIG. 6. Preferably, each standard is listed by a hyperlinked standard reference number 86, a title 88, an initial release date 90, and a latest release date 92. By selecting a hyperlinked guideline reference number 86, a corresponding standards document is displayed in a GUI.

GUI 82 also facilitates standards searches, including, but not limited to, keyword searches, advanced searches, and time line searches. The member input and the results of a standards search are similar to those for the corresponding launch element search.

As represented in block 24 of FIG. 2, members use the defined launch practice items in a launch program to improve consistency, deliverability and/or measurability of a launch practice. For example, if a member selects the “Supplier Sourcing” hyperlinked title 34 on FIG. 3, then a procedure document relating to the “Supplier Sourcing” launch element is displayed preferably as part of a GUI. The member can refer to the procedure document online or print a copy of the procedure document for offline reference. In general, procedure documents preferably include, but are not limited to, the following information: launch element, purpose, overview, deliverables by milestone (timing information), measurables by milestone, launch element owners, launch element executors, launch element contributors, and revision history.

An example of the purpose for the “Supplier Sourcing” launch element can be “to achieve cross-functional sourcing consensus in time to support product development deliverables”. It should be understood that the overview explains in detail what will be achieved. An example of a deliverable by milestone for the “Supplier Sourcing” launch element can be “modularity strategy defined” at milestone PS. An example of a measurable by milestone for the “Supplier Sourcing” launch element can be “all phase one suppliers are sourced by SI”. An example of a “Supplier Sourcing” launch element owner can be “chief program engineering”. It is understood that a launch element owner refers to an activity or department responsible for the launch element. An example of a “Supplier Sourcing” launch element executor can be “core purchasing”. It is understood that a launch element executor refers to an activity or department responsible for executing the overview of the launch element. An example of a “Supplier Sourcing” launch element contributor can be “suppliers”. It is understood that a launch element contributor refers to an activity or department that provides information necessary to accomplish the overview. Revision history can includes a list of revision dates, revised by individuals, approved by individuals, and revision descriptions.

The launch practice items improve measurability, deliverability and/or measurability in at least the following ways. The deliverables allow a launch element owner to verify that a launch element executor or contributor is delivering what is necessary for success of the launch program. The information contained in the procedure document is based on standardized best practices. Consequently, the most efficient practices are being utilized by launch program members. In addition, the standardized best practices allow measurability of the health of a launch program by providing common metrics between launch programs. Moreover, the information contained in the procedure documents reveal lessons learned that can be utilized across launch program teams. The procedure documents also provide a teachable point of view.

If a hyperlinked guideline reference number is selected, a guideline document is displayed, preferably in a GUI. For example, guideline documents can include “Drive Plan”, “Tear Down Process”, and “Drive Program Bid Formalization” documents. In general, guideline documents preferably include, but are not limited to, the following information: a guide number, a title, a revision history section, a recommended approach to complete a task, links to other launch practice items.

If a hyperlinked standards reference number is selected, a standards document is displayed, preferably in a GUI. For example, standards documents include “Build Quantities”, “Containment Plans”, and “Critical Launch Metrics”. In general, standards documents preferably include, but are not limited to, the following information: a standard number, a title, a revision history section, launch practice activities to be performed and/or measured.

As represented in block 26, member observations are accepted regarding the defined launch practice item. Preferably, a member selects the “Change Control” link from the main GUI. Upon selecting the “Change Control” link, a GUI is preferably displayed that contains a “Change Control Form”. The “Change Control Form” allows the member to enter observations regarding their experience with using a launch practice item. Observations can include a “Description of Concern”, whether the concern requires a new launch practice item or a revision to an existing launch practice item, and “Origin of Concern”. Preferably, the “Description of Concern” is entered into a data input field, the concern requirement is selected from a list of radio buttons, and the “Origin of Concern” is selected from a pull-down list. Upon completing member observations, the member preferably selects a “Submit Concern” button to submit their observations.

As represented in block 28, the defined launch practice can be modified if implementing the member observation improves the measurability and/or consistency of the launch practice. Once a member submits observations, a change control committee reviews the observations, preferably within a week. During this initial review change control meeting, the change control committee recommends to create a new launch practice item, revise an existing launch practice item, or reject revising or adding a new launch practice item in light of the observations. If the change control committee rejects revising or adding a new launch practice item, the member submitting the observations is notified preferably via e-mail with rationale concerning the rejection.

If during the initial review change control meeting a recommendation is made to create a new launch practice item or to revise an existing launch practice item, the content of the change (integrating the member observations) is presented in a content review change control meeting. If the revision or creation is approved during the content control meeting, a steering committee preferably approves the revision or creation before server 12 is updated with the documents related to the launch practice item revision/creation. Once the server 12 is updated, members can access the new or revised launch practice item. Preferably, a maximum of six months passes between the member submitting observations and updating the server 12 with launch practice item revisions/creations. Most preferably, the process takes from about one month to about three months. If the revision or creation is rejected during the content review meeting or the steering committee meeting, the member submitting the observations is notified preferably via e-mail with rationale concerning the rejection.

The following example illustrates accepting a member observation and deciding whether to revise an existing launch practice item or to create a new launch practice item. An operator can make a member observation regarding “Plant Floor FMEA”. The operator can fill out the “Change Control Form” with the observation that operator sign-off is not required during “Plant Floor PMEA”. The member observation is reviewed by the initial review change control committee. The initial review committee can decide that a revision is necessary to an existing launch practice procedure. For example, the launch practice procedure supporting “Develop/Review Process FMEAs Final” element may have to be changed to reflect the operator's observation. The initial review committee makes the change to the launch practice procedure document and the revised document is reviewed by the content control committee. Once the content control committee approves the revision, the revision is preferably presented to and approved by the steering committee. Once approved by the steering committee, server 12 is updated with the revised launch practice procedure document.

While the best mode for carrying out the invention has been described in detail, those familiar with the art to which this invention relates will recognize various alternative designs and embodiments for practicing the invention as defined by the following claims.

1. An online method for facilitating improved consistency, deliverability and/or measurability of a launch practice, the online method comprising:
determining a launch practice item based on a set of key sources wherein the launch practice item is determined by a committee separate from a launch program team; and
transmitting the launch practice item to an at least one member of the launch program team wherein the at least one member uses the launch practice item to improve consistency, deliverability and/or measurability of the launch practice.

2. The online method of claim 1 further comprising receiving an at least one member observation regarding the launch practice item.

3. The online method of claim 2 further comprising deciding to revise the launch practice item or to create a new launch practice item if implementing the observation improves the consistency, deliverability and/or measurability of the launch practice.

4. The online method of claim 3 further comprising transmitting the revised launch practice item or the new launch practice to the at least one member.

5. The online method of claim 3 wherein the deciding step lasts about one month to about three months.

6. The online method of claim 1 wherein the set of key sources includes lessons learned.

7. The online method of claim 6 wherein the set of key sources further includes launch principles, assembly plant launch process models, global craftsmanship, product quality planning initiatives, former body and assembly quality systems, former production systems, milestone standards, and product development systems.

8. The online method of claim 1 wherein the launch practice item is selected from the group consisting of launch elements, procedures, guidelines, standards, policies, and work instructions.

9. The online method of claim 8 wherein the launch practice item is a procedure and a document supporting the procedure includes measurables and deliverables.

10. The online method of claim 8 wherein the launch practice item is a standard and a document supporting the standard includes information regarding how the launch practice should be performed.

11. An online system for facilitating improved consistency, deliverability and/or measurability of a launch practice, the system comprising at least one server computer operably serving at least one client computer, the at least one server computer configured to:
(i) transmit a launch practice item to an at least one member of a launch program team wherein the at least one member uses the defined launch practice item to improve consistency, deliverability and/or measurability of the launch practice;
(ii) receive an at least one member observation regarding the launch practice item; and
(iii) transmit a revised launch practice item and/or a new launch practice item implementing the at least one member observation if implementing the observation improves the consistency, deliverability and/or measurability of the launch practice.

12. The system of claim 11 wherein the launch practice item is selected from the group consisting of launch elements, procedures, guidelines, standards, policies, and work instructions.

13. The system of claim 11 wherein the launch practice item is a procedure and a document supporting the procedure includes measurables and deliverables.

14. The system of claim 11 wherein the launch practice item is a standard and a document supporting the standard includes information regarding how the launch practice should be performed.

15. An online system for facilitating improved consistency, deliverability and/or measurability of a launch practice, the system comprising:
(i) a means for transmitting a launch practice item to an at least one member of a launch program team wherein the at least one member uses the defined launch practice item to improve consistency, deliverability and/or measurability of the launch practice;
(ii) a means for receiving an at least one member observation regarding the launch practice item; and
(iii) a means for transmitting a revised launch practice item and/or a new launch, practice item implementing the at least one member observation if implementing the observation improves the consistency, deliverability and/or measurability of the launch practice.

16. The system of claim 15 wherein the launch practice item is selected from the group consisting of launch elements, procedures, guidelines, standards, policies, and work instructions.

17. The system of claim 15 wherein the launch practice item is a procedure and a document supporting the procedure includes measurables and deliverables.

18. The system of claim 15 wherein the launch practice item is a standard and a document supporting the standard includes information regarding how the launch practice should be performed.
